(19) United States
(12) Patent Application Publication
(10) Pub. No.: US 2026/0195860 A1
(43) Pub. Date: Jul. 9, 2026

(54) IMAGE PROCESSING APPARATUS AND IMAGE PROCESSING METHOD FOR GENERATING COMPOSITE IMAGE SUBJECTED TO OCCLUSION PROCESSING

(71) Applicant: CANON KABUSHIKI KAISHA, Tokyo (JP)

(72) Inventor: SHOGO SATO, Tokyo (JP)

(21) Appl. No.: 19/404,341

(22) Filed: Dec. 1, 2025

(30) Foreign Application Priority Data
Jan. 9, 2025 (JP) 2025-003402

(51) Int. Cl. G06T 5/50; G06T 3/40; G06T 7/593; G06F 3/01

(52) U.S. Cl. CPC G06T 5/50; G06T 3/40; G06T 7/593; G06F 3/013; G06T 2207/10012; G06T 2207/10028

(57) ABSTRACT

An image processing apparatus includes one or more processors and/or circuitry configured to: execute acquisition processing of acquiring a first depth image which represents, with first resolution, a depth of a first region corresponding to a range viewed by a user in a first image, and represents, with second resolution lower than the first resolution, a depth of a second region around the first region in the first image; and execute generation processing of generating a composite image subjected to occlusion processing by combining the first image and a second image on a basis of a second depth image representing a depth of the second image and the first depth image.

### BACKGROUND

### Field of the Technology

The present disclosure relates to an image processing apparatus and an image processing method for generating a composite image subjected to occlusion processing.

### Description of the Related Art

As studies on mixed reality (MR), studies have been conducted on a technology of presenting information on a virtual space superimposed on the real space in real time. In mixed reality, for example, a composite image in which an image of a virtual space based on a position and an orientation of an imaging device is superimposed on an image of the real space captured by the imaging device is displayed.

At this time, in a case where the positional relationship between a real object and a virtual object is a specific relationship, the sense of distance between the objects may be expressed by not displaying the virtual object in a specific region of the real object (real object) in the captured image. For example, in a case where a user wearing a head-mounted display (HMD) holds the real object (his/her hand, a tool, or the like) in front of the virtual object, it is possible to implement a display in which the real object appears to exist in front of the virtual object if the virtual object is not rendered in the region of the real object in the captured image. As a result, the user can easily grasp the positional relationship between the virtual object and the real object, and thus can easily verify work using the real hand or the tool in the virtual space.

Therefore, in order to correctly express the positional relationship between the real object and the virtual object, it is necessary to measure the distance of the real object. In addition, in order to suppress image-sickness of the user, it is preferable to detect the region of the real object and measure the distance in real time (for example, a frequency of about 60 fps), but a high processing load is applied. In Japanese Patent Laid-Open No. 2022-111859, a processing load is suppressed by narrowing a region for measuring a distance of a real object to a region of an object by color extraction.

Meanwhile, resolution of MR and virtual reality (VR) images is increasing, and a processing load in rendering is high. In particular, in a case where an image of the real space and an image of a virtual space are combined in consideration of occlusion, both a depth image and the image of the virtual space are generated with high resolution, and thus the processing load is extremely high.

### SUMMARY

The present disclosure provides an image processing apparatus that implements occlusion processing with a low load.

One embodiment of the present disclosure is an image processing apparatus including one or more processors and/or circuitry configured to: execute acquisition processing of acquiring a first depth image which represents, with first resolution, a depth of a first region corresponding to a range viewed by a user in a first image, and represents, with second resolution lower than the first resolution, a depth of a second region around the first region in the first image; and execute generation processing of generating a composite image subjected to occlusion processing by combining the first image and a second image on a basis of a second depth image representing a depth of the second image and the first depth image.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of an image processing apparatus according to a first embodiment.

FIG. 2 is a software configuration diagram of the image processing apparatus according to the first embodiment.

FIG. 3 is a flowchart of occlusion processing according to the first embodiment.

FIG. 4 is a view for describing the occlusion processing according to the first embodiment.

FIG. 5 is a flowchart of occlusion processing according to a second embodiment.

FIG. 6 is a view for describing the occlusion processing according to the second embodiment.

FIG. 7 is a flowchart of occlusion processing according to a third embodiment.

FIG. 8 is a view for describing the occlusion processing according to the third embodiment.

### DESCRIPTION OF THE EMBODIMENTS

Hereinafter, embodiments of the present disclosure will be described in detail with reference to the accompanying drawings.

### First Embodiment

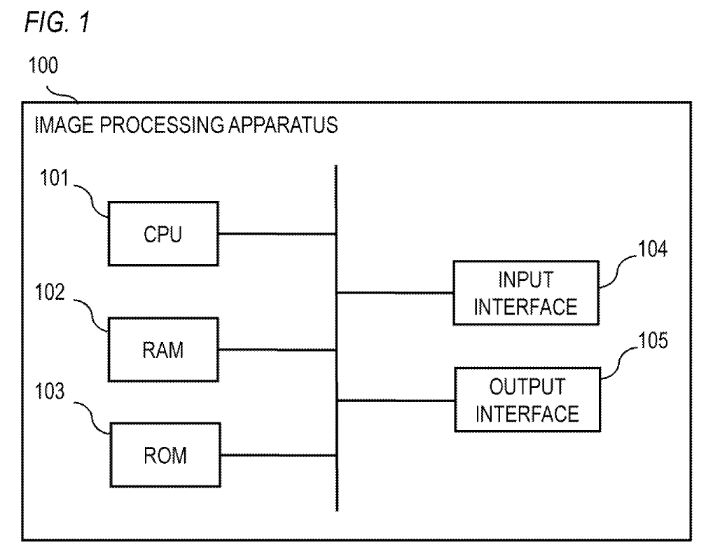

A hardware configuration of an image processing apparatus 100 according to a first embodiment will be described with reference to FIG. 1. The image processing apparatus 100 includes a central processing unit (CPU) 101, a random-access memory (RAM) 102, and a read-only memory (ROM) 103. The image processing apparatus 100 includes an input interface 104 and an output interface 105.

The CPU 101 is a control unit that controls each component of the image processing apparatus 100.

The RAM 102 is used as a work area when the CPU 101 controls each component.

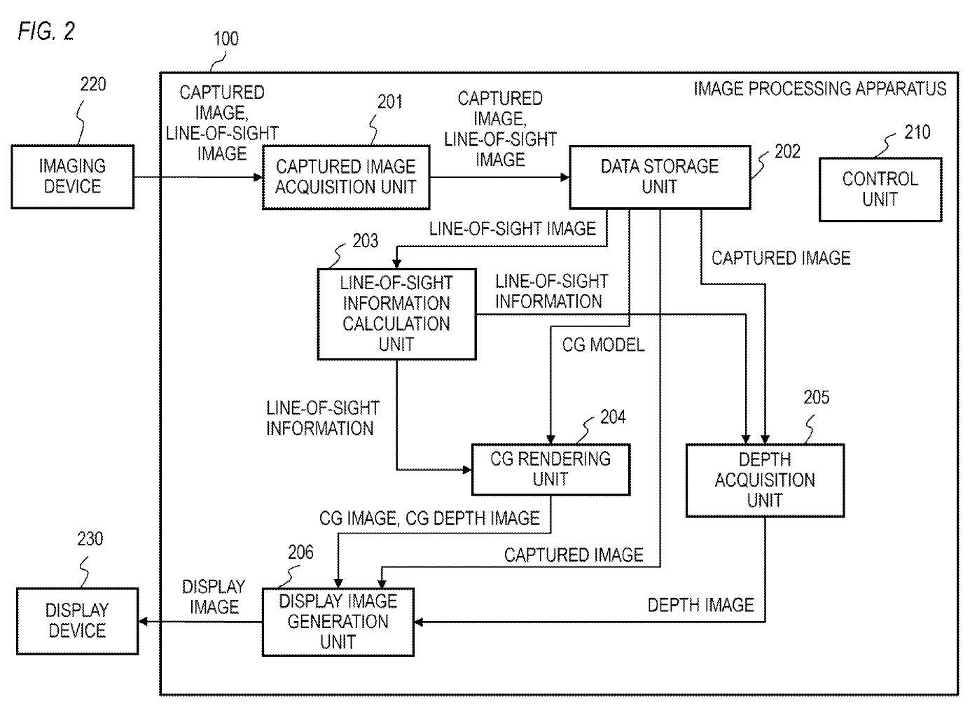

The ROM 103 stores a control program, various application programs, data, and the like. The CPU 101 loads and executes the control program, stored in the ROM 103, on the RAM 102, thereby implementing processing of each functional component in the image processing apparatus 100 illustrated in FIG. 2.

An input signal in a format that can be processed by the image processing apparatus 100 is input to the input interface 104 from an external device (such as an imaging device).

The output interface 105 outputs a display image in a format that can be processed by an external device (such as a display device).

FIG. 2 is a software block diagram of the image processing apparatus 100 according to the first embodiment. An imaging device 220 and a display device 230 are connected to the image processing apparatus 100.

The imaging device 220 is, for example, a camera incorporated in a video see-through head-mounted display (HMD). The video see-through HMD is an HMD in which an image obtained by capturing an object is displayed on a display unit in real time. The imaging device 220 captures an image of an object, such as the real space or an experiencer's own hand, in each frame to acquire the captured image. Here, the captured image acquired by the imaging device 220 is a stereo image. In addition, the imaging device 220 not only acquires the stereo image but also acquires a line-of-sight image obtained by capturing an image of the user's eyes. The line-of-sight image is acquired by, for example, a camera arranged to capture an image of the inner side of the HMD.

The display device 230 is, for example, an HMD or a display (such as a PC monitor).

The image processing apparatus 100 includes a captured image acquisition unit 201, a data storage unit 202, a line-of-sight information calculation unit 203, a CG rendering unit 204, a depth acquisition unit 205, a display image generation unit 206, and a control unit 210.

The captured image acquisition unit 201 acquires the captured image and the line-of-sight image from the imaging device 220. In addition, the captured image acquisition unit 201 stores the captured image and the line-of-sight image in the data storage unit 202.

The line-of-sight information calculation unit 203 acquires the line-of-sight image from the data storage unit 202. The line-of-sight information calculation unit 203 calculates line-of-sight information (information on a position at which the user is looking) on the basis of positions of pupils of the user's eyes in the line-of-sight image. For detection of the positions of the eyes, it is possible to use, for example, “a method of generating, in advance, a model for estimating positions of eyes from an image using deep learning (DL), and estimating a position of an object on the basis of the model”. At this time, a detector that has performed, in advance, learning based on an “image on which pupils of eyes appear” and “ground-truth coordinates of the pupils” using the DL is prepared. Then, the detector detects coordinates of a pupil in a target image by using the target image subjected to image processing as an input. Note that the line-of-sight information calculation unit 203 is not an essential component in the present embodiment in a case where it is assumed that a line of sight of the user is fixed to the vicinity of the center of a screen.

The CG rendering unit 204 acquires a CG model (virtual object model) stored in the data storage unit 202, and renders the CG as an image. Here, foveated rendering is used that utilizes a human visual characteristic that only a central field of view is seen at high resolution. In the foveated rendering, only the vicinity of the central field of view is rendered at high resolution, and a region of a peripheral field of view (around the central field of view) is rendered at low resolution. This reduces a processing load.

For example, when the line-of-sight information is acquired from the line-of-sight information calculation unit 203, the CG rendering unit 204 renders a central field of view (a central region centered on a position at which the user is looking) in the vicinity of the line of sight of the user at high resolution, and renders a region of a peripheral field of view (a peripheral region of the central region) at low resolution. Note that the CG rendering unit 204 may render a region between the central field of view and the peripheral field of view at medium resolution. In addition, the CG rendering unit 204 may decrease the resolution (pixel density) stepwise from the central field of view toward the peripheral field of view. Instead of acquiring the line-of-sight information from the line-of-sight information calculation unit 203, the CG rendering unit 204 may determine a position of the central field of view on the assumption that a position of the line-of-sight is a fixed position such as the center of the screen.

Furthermore, the CG rendering unit 204 generates an image in which a depth of the CG is rendered. Specifically, the CG rendering unit 204 generates a CG depth image in which the depth of CG is rendered at the time of rendering the CG. Resolution of the CG depth image may match resolution of the CG image.

The depth acquisition unit 205 calculates (acquires) a depth (depth information) on the basis of the captured image recorded in the data storage unit 202. As a result, the depth acquisition unit 205 generates a depth image representing the depth in the captured image. The depth typically represents a distance from the imaging device 220 that has acquired the captured image to an object appearing in pixels. For example, the depth of the entire image can be calculated on the basis of the stereo image using a method such as semi-global matching (SGM).

The display image generation unit 206 generates a composite image in which the captured image and the CG image are combined. The display image generation unit 206 also operates as a display control unit that controls the display device 230 to display the composite image.

For example, the display image generation unit 206 acquires the depth image from the depth acquisition unit 205, and acquires the CG depth image from the CG rendering unit 204. The display image generation unit 206 determines which one of a real object and the CG is in front for each pixel of the image on the basis of the depth image and the CG depth image. Thereafter, the display image generation unit 206 renders the captured image. The display image generation unit 206 acquires the CG image from the CG rendering unit 204, and renders the CG image in a pixel where the CG is in front of the real object. With this processing, the display image generation unit 206 can display the real object, which should be in front of the CG, in front of the CG.

The control unit 210 controls each component of the image processing apparatus 100.

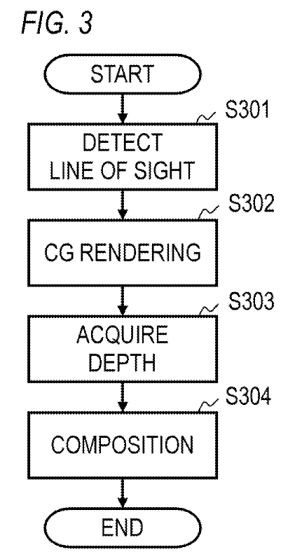

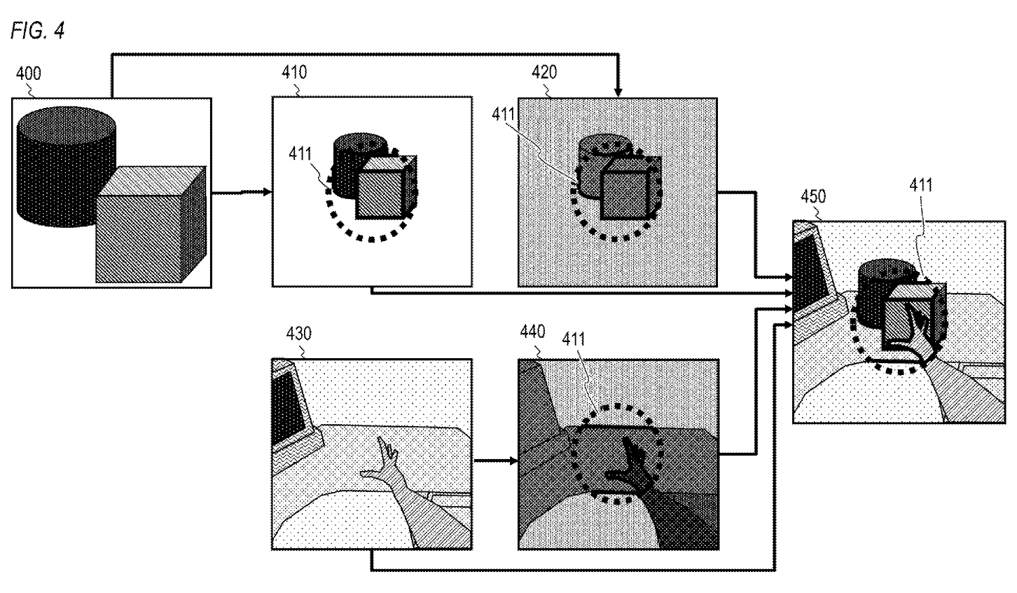

Occlusion processing according to the first embodiment will be described with reference to a flowchart of FIG. 3. The processing of this flowchart is executed (for each frame) every time the captured image stored in the data storage unit 202 is updated by the captured image acquisition unit 201. The processing of this flowchart is implemented by the control unit 210 controlling each component. Here, the occlusion processing will be described with reference to an example illustrated in FIG. 4.

In step S301, the line-of-sight information calculation unit 203 acquires a line-of-sight image from the data storage unit 202. The line-of-sight information calculation unit 203 calculates line-of-sight information on the basis of positions of pupils of user's eyes in the line-of-sight image.

In step S302, the CG rendering unit 204 acquires a CG model stored in the data storage unit 202, and renders the CG model as an image. In the example of FIG. 4, a CG image 410 and a CG depth image 420 are generated by rendering a CG model 400 viewed from viewpoints of the left and right eyes. At this time, the CG rendering unit 204 renders, for each of the two images, a region in a central field of view 411 (a region corresponding to a range viewed by the user) at high resolution (first resolution) and the other region at low resolution (second resolution lower than the first resolution). This reduces the processing load at the time of rendering. Note that resolution in the depth direction in the region included in the central field of view 411 and resolution in the depth direction in the other region may be the same.

In step S303, the depth acquisition unit 205 calculates a depth on the basis of a captured image (a current image obtained by capturing the real space) recorded in the data storage unit 202. In the example of FIG. 4, the depth acquisition unit 205 calculates a depth image 440 on the basis of a captured image 430 configured as a stereo image. At this time, the depth acquisition unit 205 calculates a region included in the central field of view 411 with high resolution (third resolution), and calculates a region of a peripheral field of view, which is the other region, with low resolution (fourth resolution lower than the third resolution). As a result, a processing load in the depth calculation is reduced. Note that the resolution in the depth direction in the region included in the central field of view 411 and the resolution in the depth direction in the region of the peripheral field of view may be the same. In addition, the third resolution may be the same as the first resolution, and the fourth resolution may be the same as the second resolution.

In order to reduce resolution in an image direction (up, down, left, and right directions) and resolution in the depth direction, the depth acquisition unit 205 may calculate a depth of the peripheral field of view by reducing resolution of the captured image and then calculating, by stereo matching, a depth of the captured image whose resolution has reduced. Furthermore, the depth acquisition unit 205 may reduce only the resolution in the depth direction by decimating a matching destination of the stereo matching without reducing the captured image at the time of the stereo matching. When calculating the depth, the depth acquisition unit 205 estimates the depth of only the peripheral field of view not including the central field of view 411 with low resolution (the fourth resolution), then calculates a depth of only the central field of view 411 with high resolution (the third resolution), and combines the both. Alternatively, the depth acquisition unit 205 may calculate the depth of the region of the entire captured image 430 including both the central field of view 411 and the peripheral field of view with low resolution (the fourth resolution), and then calculate only the central field of view 411 with high resolution on the basis of the depth of the region of the entire captured image 430 calculated with low resolution. At this time, the depth acquisition unit 205 may reduce the processing load by narrowing a depth search range to the vicinity of the depth at low resolution.

In step S304, the display image generation unit 206 generates a composite image in which the captured image and the CG image are combined. The display image generation unit 206 controls the display device 230 to display the composite image. In the example of FIG. 4, the display image generation unit 206 compares the CG depth image 420 and the depth image 440, and determines which one of the real object and the CG is in front for each pixel of the image. Thereafter, after rendering the captured image 430, the display image generation unit 206 renders a color of the CG image 410 in a pixel in which the CG is in front of the real object in the CG image 410. As a result, the display image generation unit 206 generates a display image 450 as the composite image subjected to the occlusion processing.

Note that the first embodiment has been described above on the assumption that the imaging device 220 is a camera that acquires a color image, but the imaging device 220 may include a plurality of depth sensors different in resolution. In this case, a high-resolution depth sensor having high power consumption captures only a central field of view in the real space to acquire a depth of the central field of view. On the other hand, a low-resolution depth sensor having low power consumption captures only a peripheral field of view in the real space to acquire a depth of the peripheral field of view. Alternatively, the depth of the peripheral field of view is calculated with low resolution by capturing with the low-resolution depth sensor, and then the depth of the central field of view may be calculated with high resolution by stereo matching. In addition, the peripheral field of view may be captured by the low-resolution depth sensor to calculate the depth of the peripheral field of view with low resolution, and the depth of the central field of view may be calculated with high resolution by stereo matching. Furthermore, a depth of the entire captured image including the peripheral field of view may be calculated with low resolution by capturing with the low-resolution depth sensor, and then the depth of the central field of view may be calculated with high resolution by stereo matching on the basis of the depth of the entire captured image calculated with low resolution.

In addition, there is a possibility that a region whose depth is not calculated in a captured image is generated due to a difference in position and orientation between a real object appearing in the captured image and a depth sensor. The depth acquisition unit 205 may interpolate (fill) such a region whose depth is not obtained. In this case, the depth acquisition unit 205 may interpolate a depth of a peripheral field of view with low resolution and interpolate a depth of a central field of view with high resolution.

According to the first embodiment, since the resolution is more appropriately controlled for each region in the image representing the depth, it is possible to provide the occlusion processing operable with a low load.

### Second Embodiment

In a second embodiment, the image processing apparatus 100 further reduces a processing load by applying a difference for each region to an update (calculation) frequency of depth estimation based on a current imaging result of the real space. Note that, hereinafter, “update of depth estimation based on a current imaging result of the real space” is simply referred to as “update of a depth”.

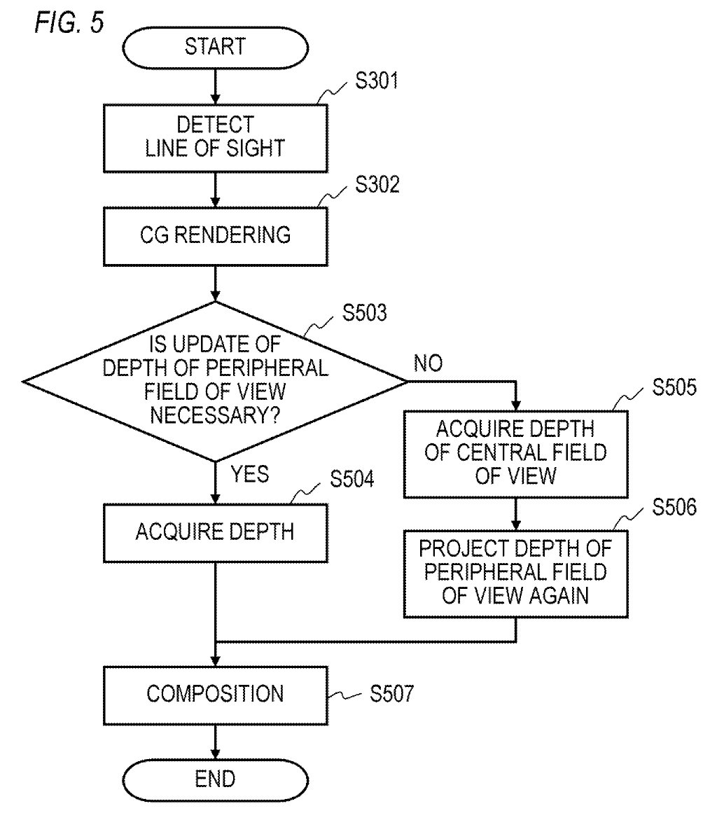

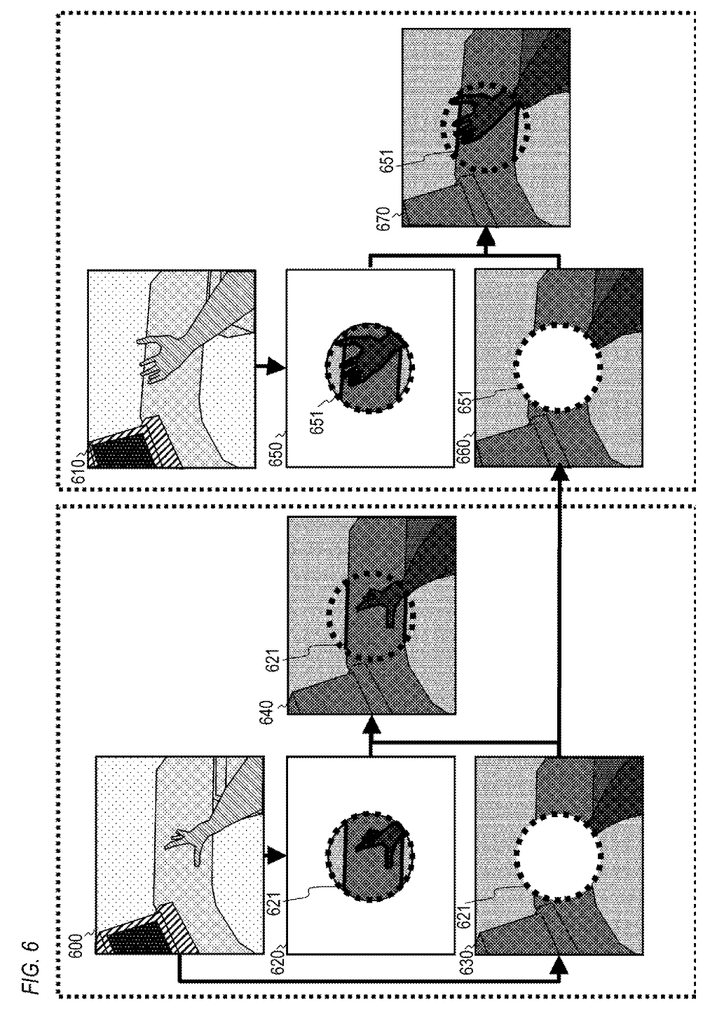

Occlusion processing according to the second embodiment will be described with reference to a flowchart of FIG. 5. The processing of this flowchart is executed by the control unit 210 controlling each component every time a captured image of the data storage unit 202 is updated by the captured image acquisition unit 201. Here, depth calculation processing will be described with reference to an example illustrated in FIG. 6.

In step S503, the depth acquisition unit 205 determines whether or not update of a depth of a peripheral field of view is necessary. If it is determined that the update of the depth of the peripheral field of view is necessary, the processing proceeds to step S504. If it is determined that the update of the depth of the peripheral field of view is unnecessary, the processing proceeds to step S505.

For example, the depth acquisition unit 205 determines that the update of the depth of the peripheral field of view is necessary in a case where a certain period of time has elapsed since the latest time point at which the depth of the peripheral field of view is updated (the latest time point at which the depth of the peripheral field of view is calculated on the basis of an imaging result). Alternatively, the depth acquisition unit 205 may determine that the update of the depth is necessary in a case where a position or an orientation of the imaging device 220 has changed by a certain degree (certain amount) or more since the last update of the depth of the peripheral field of view.

In step S504, the depth acquisition unit 205 calculates a depth of the entire captured image on the basis of the captured image recorded in the data storage unit 202. Here, similarly to the first embodiment, the depth acquisition unit 205 calculates a depth of a central field of view with high resolution and calculates the depth of the peripheral field of view with low resolution. At this time, the depth acquisition unit 205 stores, in the data storage unit 202, a depth image of the peripheral field of view and information on the position and orientation of the imaging device 220. In the example of FIG. 6, the depth acquisition unit 205 generates a “central depth image 620 obtained by calculating a depth of a central field of view 621 from a captured image 600 with high resolution” and a “peripheral depth image 630 obtained by calculating a depth of the peripheral field of view with low resolution”. Then, the depth acquisition unit 205 combines the central depth image 620 and the peripheral depth image 630 to generate a depth image 640. Then, the depth acquisition unit 205 stores the peripheral depth image 630 and the position and orientation of the imaging device 220 in the data storage unit 202.

In step S505, the depth acquisition unit 205 calculates a depth of only the central field of view on the basis of the captured image recorded in the data storage unit 202. In the example of FIG. 6, the depth acquisition unit 205 generates a central depth image 650 in which a depth of a central field of view 651 is calculated with high resolution from a captured image 610.

In step S506, the depth acquisition unit 205 reads a depth image of the peripheral field of view recorded in the data storage unit 202 and a position and an orientation of the imaging device 220 at the time of previous update of the peripheral field of view. The depth acquisition unit 205 converts a position and an orientation of the peripheral field of view at the time of update into the current position and orientation on the basis of a transformation matrix of an image calculated from the positions and orientations of the imaging device 220 at present and at the time of update.

In the example of FIG. 6, the depth acquisition unit 205 reads the past peripheral depth image 630 and the past position and orientation, and calculates the transformation matrix to the current position and orientation. Thereafter, the depth acquisition unit 205 projects the peripheral depth image 630 onto the current position and orientation on the basis of the transformation matrix to correct the peripheral depth image 630 (the depth represented by the peripheral depth image 630). As a result, the depth acquisition unit 205 generates a peripheral depth image 660. Then, the depth acquisition unit 205 combines the central depth image 650 and the peripheral depth image 660 to generate a depth image 670.

In step S507, the display image generation unit 206 generates a composite image in which a captured image and a CG image are combined on the basis of a CG depth image and a depth image. Then, the display image generation unit 206 controls the display device 230 to display the composite image.

According to the second embodiment, in a specific case, the image processing apparatus 100 calculates the depth of the peripheral field of view by a specific method based on the imaging result as in the first embodiment. On the other hand, in a case different from the specific case, the image processing apparatus 100 calculates a new depth of the peripheral field of view by correcting the depth of the peripheral field of view calculated in the past by the specific method. As a result, an update frequency of the depth of the peripheral field of view is lower than an update frequency of the depth of the central field of view. As a result, it is possible to provide the occlusion processing operable with a much lower load than that in the first embodiment.

### Third Embodiment

As in the depth image 670 of FIG. 6, there is a case where an object (hereinafter referred to as “moving object”), such as a hand moving in space independently of a movement of a head, is located at a boundary (gap) between a central field of view and a peripheral field of view. In this case, if the occlusion processing according to the second embodiment is executed, continuity of a depth image is not appropriate, and as a result, a composite image that causes discomfort may be generated. A third embodiment provides occlusion processing capable of updating, with a low load, a composite image that is less likely to cause discomfort even in a case where there is a moving object.

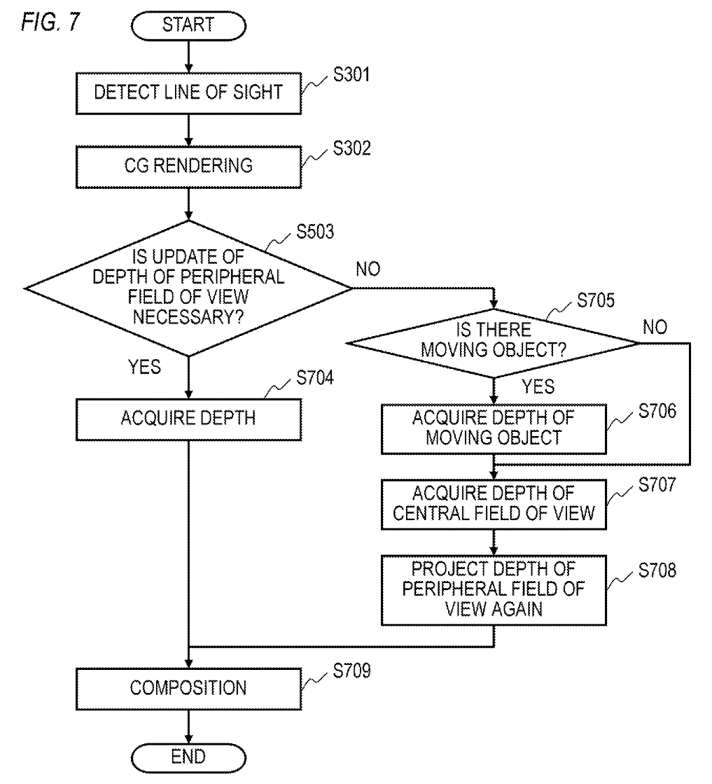

A flowchart of the occlusion processing according to the third embodiment will be described with reference to a flowchart of FIG. 7. The processing of this flowchart is executed by the control unit 210 controlling each component (for each frame) every time a captured image stored in the data storage unit 202 is updated by the captured image acquisition unit 201.

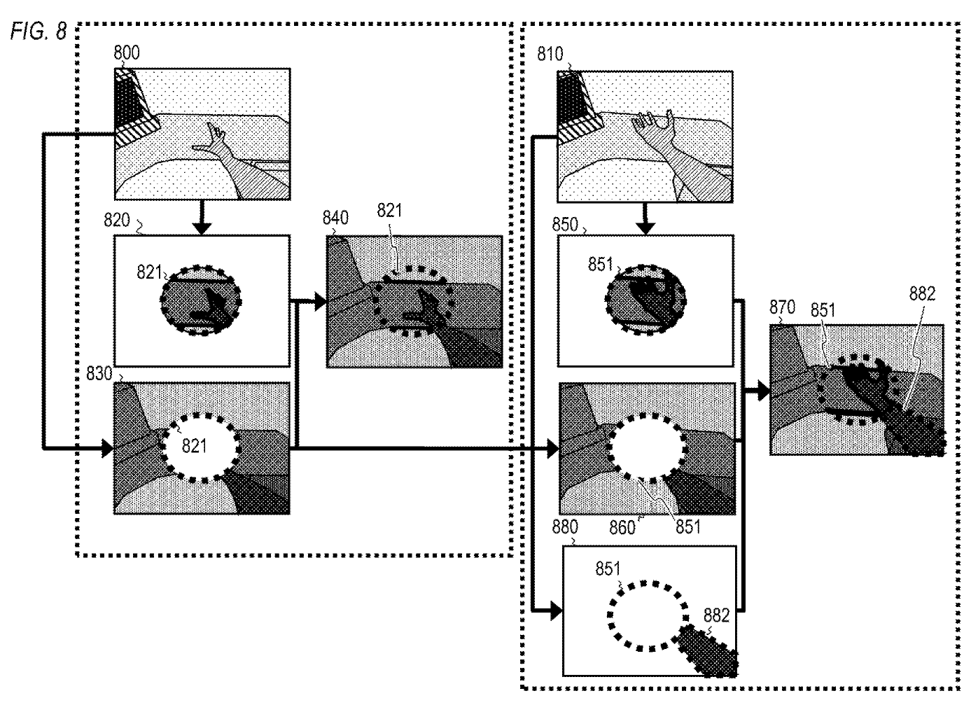

In step S704, as in step S504, the depth acquisition unit 205 calculates a depth of the entire captured image on the basis of the captured image recorded in the data storage unit 202. In an example of FIG. 8, the depth acquisition unit 205 generates a central depth image 820 representing a depth of a central field of view 821 with high resolution and a peripheral depth image 830 representing a depth of a peripheral field of view with low resolution on the basis of a captured image 800. The depth acquisition unit 205 combines the central depth image 820 and the peripheral depth image 830 to generate a depth image 840. Then, the depth acquisition unit 205 stores the peripheral depth image 830 and a position and an orientation of the imaging device 220 in the data storage unit 202.

In step S705, the depth acquisition unit 205 determines whether or not there is a moving object in the captured image. If it is determined that there is a moving object, the processing proceeds to step S706. If it is determined that there is no moving object, the processing proceeds to step S707. For example, the depth acquisition unit 205 can detect the presence of a moving object by extraction based on a color and a threshold, edge detection and tracking, background subtraction, detection by a convolutional neural network, or a combination of these.

In step S706, the depth acquisition unit 205 calculates a depth of a moving object region (a region of the moving object) on the basis of the captured image recorded in the data storage unit 202. At this time, the depth of the moving object region may be calculated with high resolution with priority given to quality, or may be calculated with low resolution with priority given to a processing load. In the example of FIG. 8, the depth acquisition unit 205 generates a moving object depth image 880 by calculating a depth of a moving object region 882 not included in a central field of view 851 in a hand-arm region appearing in the captured image. Note that the moving object region 882 may be a region in which the moving object is roughly surrounded by a rectangle or the like, or may be a region calculated in units of pixels as illustrated in FIG. 8.

In step S707, the depth acquisition unit 205 calculates a depth of only the central field of view on the basis of the captured image recorded in the data storage unit 202. In the example of FIG. 8, the depth acquisition unit 205 generates a central depth image 850 representing the depth of the central field of view 851 with high resolution on the basis of the captured image 800.

In step S708, the depth acquisition unit 205 reads a depth image of the peripheral field of view recorded in the data storage unit 202 and a position and an orientation of the imaging device 220 at the time of update of the peripheral field of view. The depth acquisition unit 205 calculates a transformation matrix of an image based on the positions and postures of the imaging device 220 at present and at the time of update of the peripheral field of view, and converts the position and orientation of the peripheral field of view into the current position and orientation according to the transformation matrix.

In the example of FIG. 8, the depth acquisition unit 205 reads the past peripheral depth image 830 and the past position and orientation, and calculates a transformation matrix for transforming the past position and orientation into the current position and orientation. Thereafter, the depth acquisition unit 205 projects the peripheral depth image 830 onto the current position and orientation to generate a peripheral depth image 860. Then, the depth acquisition unit 205 combines the central depth image 850, the peripheral depth image 860, and the moving object depth image 880 to generate a depth image 870.

In step S709, the display image generation unit 206 generates a composite image obtained in which a captured image and a CG image are combined on the basis of a CG depth image and a depth image. The display image generation unit 206 controls the display device 230 to display the composite image.

According to the third embodiment, the entire depth of the moving object region is calculated for each frame with low resolution or high resolution. As a result, even in a case where there is a moving object, it is possible to generate a composite image that is less likely to cause discomfort as compared with the second embodiment.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is equal to or smaller than B, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. For this reason, unless there is a contradiction, “A or more” may be read as “larger (higher; longer; more) than A”, and “A or less” may be read as “smaller (lower; shorter; less) than A". Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, occlusion processing can be implemented with a low load.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-003402, filed January 9, 2025, which is hereby incorporated by reference herein in its entirety.

What is claimed is:

1. An image processing apparatus comprising one or more processors and/or circuitry configured to:
execute acquisition processing of acquiring a first depth image which represents, with first resolution, a depth of a first region corresponding to a range viewed by a user in a first image, and represents, with second resolution lower than the first resolution, a depth of a second region around the first region in the first image; and
execute generation processing of generating a composite image subjected to occlusion processing by combining the first image and a second image on a basis of a second depth image representing a depth of the second image and the first depth image.

2. The image processing apparatus according to claim 1, wherein
in the acquisition processing, resolution of the first image is reduced, and then a depth of the first image with the reduced resolution is calculated to calculate the depth of the second region.

3. The image processing apparatus according to claim 1, wherein
in the acquisition processing, the depth of the second region is calculated using a depth sensor.

4. The image processing apparatus according to claim 1, wherein
in the acquisition processing,
a depth of an entire first image is calculated with the second resolution to calculate the depth of the second region, and
the depth of the first region is acquired on a basis of a result of calculating the depth of the entire first image with the second resolution.

5. The image processing apparatus according to claim 1, wherein
in the acquisition processing,
in a first case, the depth of the second region is calculated with the second resolution by a first method, and
in a second case, a new depth of the second region is acquired by correcting the depth of the second region calculated by the first method previously.

6. The image processing apparatus according to claim 5, wherein
the first case is a case where a certain period of time has elapsed from a latest time point at which the depth of the second region is calculated by the first method.

7. The image processing apparatus according to claim 5, wherein
in the acquisition processing, the depth of the first region is calculated with the first resolution by a second method in both the first case and the second case.

8. The image processing apparatus according to claim 7, wherein
both the first method and the second method are methods based on a result of capturing a current image of a real space.

9. The image processing apparatus according to claim 1, wherein
in the acquisition processing, the depth of the first region and a depth of a region of a moving object are calculated with the first resolution.

10. The image processing apparatus according to claim 1, wherein
in the first depth image, resolution in a depth direction of the second region is identical to resolution in the depth direction of the first region.

11. The image processing apparatus according to claim 1, wherein
the first image is an image in which a real space is captured.

12. An image processing method comprising:
acquiring a first depth image which represents, with first resolution, a depth of a first region corresponding to a range viewed by a user in a first image, and represents, with second resolution lower than the first resolution, a depth of a second region around the first region in the first image; and
generating a composite image subjected to occlusion processing by combining the first image and a second image on a basis of a second depth image representing a depth of the second image and the first depth image.

13. A non-transitory computer readable medium that stores a program, wherein the program causes a computer to execute an image processing method comprising:
acquiring a first depth image which represents, with first resolution, a depth of a first region corresponding to a range viewed by a user in a first image, and represents, with second resolution lower than the first resolution, a depth of a second region around the first region in the first image; and
generating a composite image subjected to occlusion processing by combining the first image and a second image on a basis of a second depth image representing a depth of the second image and the first depth image.
